(19) United States
(12) Patent Application Publication
(10) Pub. No.: US 2007/0216814 A1
(43) Pub. Date: Sep. 20, 2007

(54) Receiver apparatus and receiver system

(75) Inventor: Hitoshi Azuma, Tenri-shi (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/634,197

(22) Filed: Dec. 6, 2006

(30) Foreign Application Priority Data
Mar. 15, 2006 (JP) 2006-070107

(51) Int. Cl. H04N 9/68

(52) U.S. Cl. 348/646

(57) ABSTRACT

A receiver apparatus 3 has a digital circuit portion 13 that converts a compressed digital signal outputted from a digital demodulating portion 12 into digital video and audio signals and a video/audio output circuit 14 that converts the digital video and audio signals outputted from the digital circuit portion 13 into analog video and audio signals. With this configuration, a video/audio processing IC for digital signal processing no longer needs to be mounted on the circuit board of a video display apparatus 4, and thus a receiver system can be realized with a video display apparatus having a simple configuration.

This nonprovisional application claims priority under 35 U.S.C. §119(a) on Patent Application No. 2006-070107 filed in Japan on Mar. 15, 2006, the entire contents of which are hereby incorporated by reference.

### BACKGROUND OF THE INVENTION

1. Field of the Invention

The present invention relates to a receiver apparatus and a receiver system for receiving a radio-frequency signal such as a digital television broadcast signal.

2. Description of Related Art

FIG. 4 is a block diagram showing an outline of the configuration of an example of a conventional receiver system. The receiver system 900 shown in FIG. 4 is composed of: an antenna 901 for receiving a radio-frequency signal; a receiver apparatus 902 for performing predetermined processing on the signal received by the antenna 901 to obtain a desired signal; and a video display apparatus 903 for performing predetermined processing on the signal obtained by the receiver apparatus 903 for performing predetermined processing on the signal obtained by the receiver apparatus 902 to extract video and audio signals. The receiver apparatus 902 is provided with: a tuner circuit portion 911 that converts the radio-frequency signal received by the antenna 901 into an intermediate-frequency signal outputted from the tuner circuit portion 911 and the digital demodulating portion 912 with electric power from which they operate. The digital demodulating portion 912 is provided with a digital demodulating IC 914, which is a processing IC for converting the intermediate-frequency signal into a digital signal.

The video display apparatus 903 is provided with: a digital circuit portion 921 that converts the compressed digital signal fed from the receiver apparatus 902 into digital video and audio signals; a video/audio output circuit 922 that converts the digital video and audio signals outputted from the digital circuit portion 921 into analog video and audio signals; a display processing portion 923 that performs processing for displaying video based on the analog video signal outputted from the video/audio output circuit 922; an audio processing portion 924 that performs processing for outputting audio based on the analog audio signal outputted from the video/audio output circuit 922; and a power supply portion 925 that supplies the digital circuit portion 921, the video/audio output circuit 922, the display processing portion 923, and the audio processing portion 924 with electric power from which they operate. The digital circuit portion 921 is provided with: a video/audio processing IC 928 for extracting video and audio signals from the compressed digital signal; a video/audio processing memory 926 for temporarily storing data being processed during video/audio processing; and a program memory 927 for storing control codes for controlling the receiver apparatus.

In this conventional receiver system 900 configured as described above, the receiver apparatus 902 is electromagnetically shielded by being covered with a shield. On the other hand, the video display apparatus 903 has different functional sections mounted on the circuit board thereof, namely the video/audio processing IC 928, the video/audio processing memory 926, the program memory 927, the video/audio output circuit 922, the display processing portion 923, and the audio processing portion 924. This requires an accordingly large number of components and conductors to be mounted and laid on the circuit board of the video display apparatus 903, which thus necessitates the use of a multiple-layer circuit board.

Furthermore, the above-mentioned functional sections mounted on the circuit board of the video display apparatus 903, namely the video/audio processing IC 928, the video/audio processing memory 926, the program memory 927, the video/audio output circuit 922, the display processing portion 923, and the audio processing portion 924, generate unnecessary electromagnetic emission and noise, against which measures need to be taken on the video display apparatus 903 as by providing it with an additional shield.

Moreover, the above-mentioned functional sections mounted on the circuit board of the video display apparatus 903, namely the video/audio processing IC 928, the video/audio processing memory 926, the program memory 927, the video/audio output circuit 922, the display processing portion 923, and the audio processing portion 924, also generate heat, against which measures need to be taken as by increasing the area of the circuit board or providing it with an additional heat-dissipating plate.

### SUMMARY OF THE INVENTION

In view of the conventionally encountered inconveniences mentioned above, it is an object of the present invention to provide a receiver system provided with a video display apparatus having a simple configuration.

To achieve the above object, according to one aspect of the present invention, a receiver apparatus that converts a radio-frequency signal received by an antenna into video and audio signals is provided with: a tuner circuit portion that converts the radio-frequency signal received by the antenna into an intermediate-frequency signal; a digital demodulating portion that converts the intermediate-frequency signal outputted from the tuner circuit portion into a compressed digital signal; a digital circuit portion that converts the compressed digital signal outputted from the digital demodulating portion into digital video and audio signals; and a video/audio output circuit that converts the digital video and audio signals outputted from the digital circuit portion into analog video and audio signals. Here, the tuner circuit portion, the digital demodulating portion, the digital circuit portion, and the video/audio output circuit are arranged on a single circuit board, and the top and bottom faces of the single circuit board are entirely covered with a chassis. The single circuit board may be enclosed in the chassis.

When the digital circuit portion and the video/audio output circuit are mounted on the circuit board of the receiver apparatus as described above, a video display apparatus for displaying video based on a video signal outputted from the receiver apparatus and outputting audio based on an audio signal outputted from the receiver apparatus needs to be provided only with a display processing portion for displaying video based on the video signal fed from the receiver apparatus and an audio processing portion for outputting audio based on the audio signal fed from the receiver apparatus, and thus does not need to be built on a multiple-layer circuit board. Furthermore, measures against heat generated by the digital circuit portion and the video/audio output circuit can be taken in the receiver apparatus, and hence, in the video display apparatus, no measures need to be taken against heat as by increasing the area of the circuit board or providing it with an additional heat-dissipating plate. Moreover, no output terminal for outputting a signal from the tuner circuit portion needs to be arranged outside the chassis, and this prevents noise from outside the receiver apparatus from entering the tuner circuit portion, and thus helps prevent degradation of the performance of the tuner circuit portion.

For example, the tuner circuit portion may be separated from the digital demodulating portion and the digital circuit portion with a first shield plate, the analog ground pattern of the tuner circuit portion and the digital ground patterns of the digital demodulating portion and the digital circuit portion may be electrically connected to the chassis, and the ground patterns of the circuit board (the single circuit board) may be connected to the chassis with solder applied on one face of the single circuit board. Incidentally, here, the ground patterns may be connected to the chassis with solder applied on the bottom face of the single circuit board. Here, the bottom face of the single circuit board denotes the face thereof at which the distance therefrom to the lid is smaller, in other words, the face thereof at which the height with respect thereto of the side faces of the chassis is smaller.

With this configuration, there is no need to turn the single circuit board over while, in the manufacturing process of the receiver apparatus, connecting the ground patterns of the single circuit board to the chassis, and hence it is possible to reduce the number of manufacturing steps.

The ground patterns may be connected to the chassis with solder applied at all (or a plurality of) edges of the single circuit board.

With this configuration, the chassis and the ground patterns are connected at an increased number of points, and this helps reduce impedance.

The input/output terminals of the tuner circuit portion, the digital demodulating portion, the digital circuit portion, and the video/audio output circuit may be arranged in a concentrated fashion at one edge of the single circuit board so as to extend outward therefrom in a direction substantially perpendicular thereto, and the one edge may be substantially parallel to the axis of the tuner input terminal via which the radio-frequency signal received by the antenna is fed to the tuner circuit portion.

With this configuration, whether the receiver apparatus is mounted on the video display apparatus in a flat position or in an upright position with the edge thereof where the input/output terminals are arranged serving as the base, the mounting of the receiver apparatus can be coped with simply by bending or leaving straight the pins of the input/output terminals. Thus, whichever of the two arrangements is desirable can be adopted with no design change as in component layout.

With respect to the single circuit board, the input/output terminals of the tuner circuit portion, the digital demodulating portion, the digital circuit portion and the video/audio output circuit may be connected to the circuit board with solder applied on the same face thereof on which the ground patterns of the single circuit board are connected to the chassis with solder.

With this configuration, there in no need to turn the circuit board over each time, in the manufacturing process of the receiver apparatus, the input/output terminals are soldered to the circuit board or the ground patterns of the circuit board are soldered to the chassis, and hence it is possible to reduce the number of manufacturing steps.

A receiver system that receives digital and analog broadcast signals, converts them into video and audio signals, and displays video and/or outputs audio according thereto may be so built as to be provided with: a receiver apparatus having one of the above described configurations; and a video display apparatus that displays video based on the video signal outputted from the receiver apparatus and/or outputs audio based on the audio signal outputted from the receiver apparatus.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a block diagram showing an outline of the configuration of a receiver system according to the present invention;

FIG. 2A is a diagram schematically showing how different functional sections are mounted on the receiver apparatus 3 shown in FIG. 1 (as seen from the top face thereof);

FIG. 2B is a diagram schematically showing how different functional sections are mounted on the receiver apparatus 3 shown in FIG. 1 (as seen from the bottom face thereof);

FIG. 3A is a diagram conceptually showing how the receiver apparatus 3 and the video display apparatus 4 are fitted together, showing the state where the receiver apparatus 3 is fitted in an upright position on the video display apparatus 4;

FIG. 3B is a diagram conceptually showing how the receiver apparatus 3 and the video display apparatus 4 are fitted together, showing the state where the receiver apparatus 3 is fitted in a flat position on the video display apparatus 4; and

FIG. 4 is a block diagram showing an outline of the configuration of a conventional receiver system.

### DETAILED DESCRIPTION OF PREFERRED EMBODIMENTS

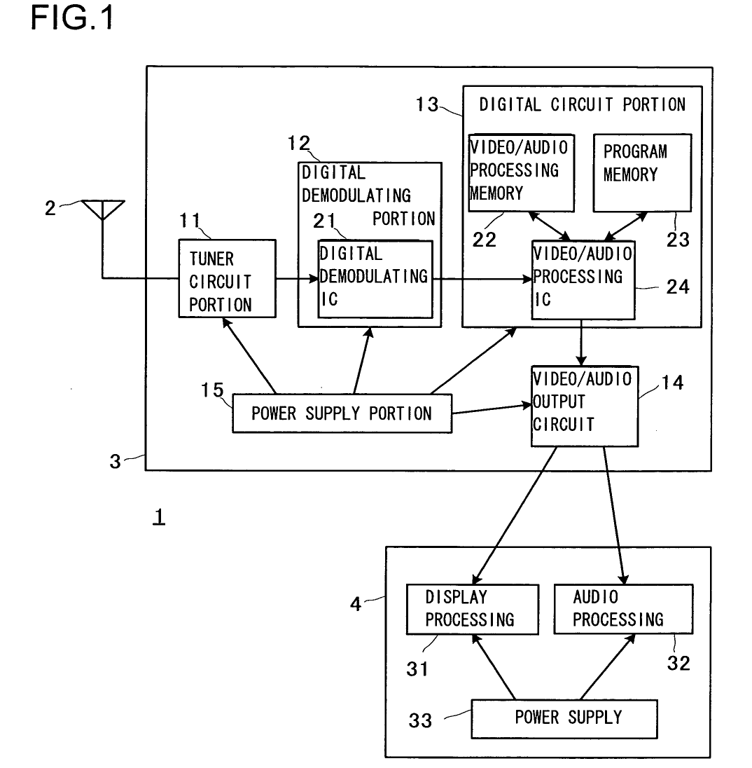

Hereinafter, the configuration of a receiver system according to the present invention will be described with reference to the accompanying drawings. FIG. 1 is a block diagram showing an outline of the configuration of a receiver system according to the present invention.

The receiver system 1 shown in FIG. 1 is composed of: an antenna 2 for receiving a radio-frequency signal; a receiver apparatus 3 for performing predetermined processing on the signal received by the antenna 2 to acquire video and audio signals; and a video display apparatus 4 for displaying video based on the video signal fed from the receiver apparatus 3 and/or outputting audio based on the audio signal fed from the receiver apparatus 3. The antenna 2 is connected via a coaxial cable to a tuner input terminal of the receiver apparatus 3, and an interface terminal of the receiver apparatus 3 is connected to the video display apparatus 4.

The receiver apparatus 3 is provided with: a tuner circuit portion 11 that converts the radio-frequency signal received by the antenna 2 into an intermediate-frequency signal (hereinafter referred to as the “IF signal”); a digital demodulating portion 12 that converts the IF signal outputted from the tuner circuit portion 11 into a compressed digital signal; a digital circuit portion 13 that converts the compressed digital signal outputted from the digital demodulating portion 12 into digital video and audio signals; a video/audio output circuit 14 that converts the digital video and audio signals outputted from the digital circuit portion 13 into analog video and audio signals; and a power supply portion 15 that supplies the tuner circuit portion 11, the digital demodulating portion 12, the digital circuit portion 13, and the video/audio output circuit 14 with electric power from which they operate.

The digital demodulating portion 12 is provided with a digital demodulating IC 21, which is a processing IC for converting the IF signal into a digital signal. The digital circuit portion 13 is provided with: a video/audio processing IC 24 for extracting video and audio signals from the compressed digital signal; a video/audio processing memory 22 for storing the compressed digital video and audio signals and decoded digital video and audio signals; and a program memory 23 for storing control codes for controlling the receiver apparatus. A serial control signal for controlling the tuner circuit portion 11 and the digital demodulating IC 21 is fed to the video/audio processing IC 24.

The video display apparatus 4 is provided with: a display processing portion 31 for performing processing for displaying video based on the analog video signal fed from the receiver apparatus 3; an audio processing portion 32 for performing processing for outputting audio based on the analog audio signal fed from the receiver apparatus 3; and a power supply portion 33 for supplying the display processing portion 31 and the audio processing portion 32 with electric power from which they operate.

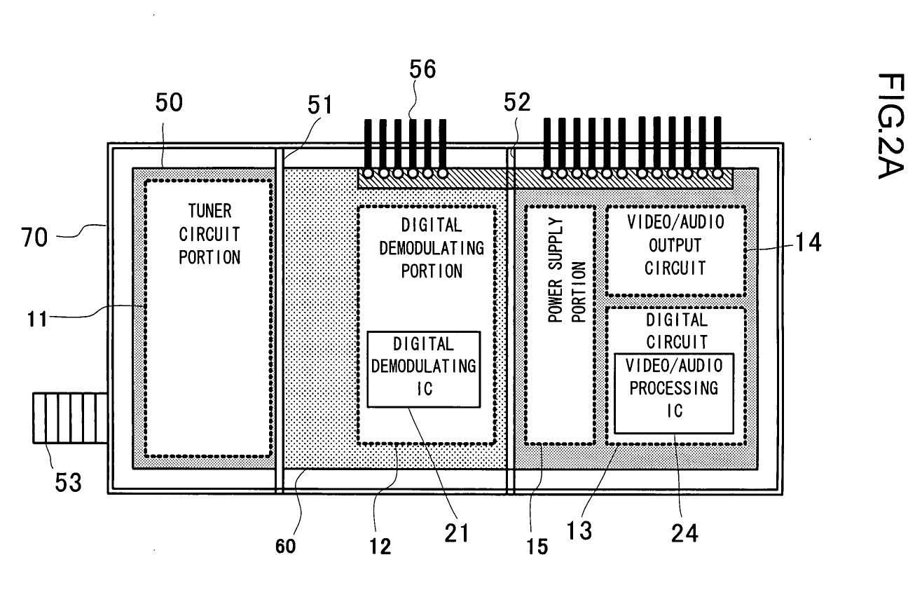

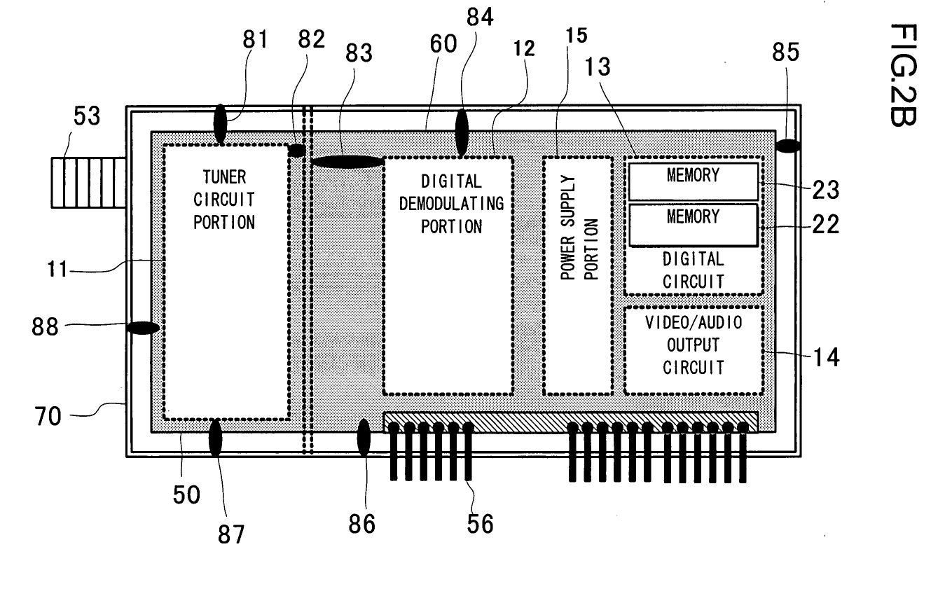

FIGS. 2A and 2B are diagrams schematically showing how different functional sections are mounted on the receiver apparatus 3 shown in FIG. 1, FIG. 2A showing the receiver apparatus 3 as seen from one side (top face) thereof and FIG. 2B showing the receiver apparatus 3 as seen from the other side (bottom face) thereof.

As shown in FIG. 2A, the receiver apparatus 3 divides into an analog part 50 and a digital part 60, and a first shield plate 51 is placed between the analog part 50 and the digital part 60 so as to electromagnetically shield them from each other.

In the analog part 50, the tuner circuit portion 11 is mounted. The analog part 50 is fitted to a chassis 70, and the analog ground pattern of the tuner circuit portion 11 is electrically connected to the chassis 70. The analog part 50 is further provided with a tuner input terminal 53, via which the radio-frequency signal received by the antenna 2 is fed to the tuner circuit portion 1. Incidentally, the chassis 70 has lids fitted thereto, one on the top face and another on the bottom face thereof, and thereby the analog part 50 and the digital part 60 are covered with a shield.

The top and bottom faces of the circuit board may be entirely covered with the chassis 70; or the circuit board may be enclosed in the chassis 70, or the circuit board may be substantially hermetically enclosed in the chassis 70. In any of these ways, it is possible to minimize the entry of noise from outside into the components on the circuit board.

In the digital part 60 are mounted the digital demodulating portion 12, the digital circuit portion 13, the video/audio output circuit 14, and the power supply portion 15. As described above, the digital part 60 is electromagnetically shielded from the analog part 50 with the first shield plate 51 placed therebetween.

The digital part 60 is further provided with a connector 56 at one edge thereof. The connector 56 includes, in addition to the input/output terminals of the tuner circuit portion 11, the input/output terminals related to the functional sections mounted on the digital part 60, namely the digital demodulating portion 12, the digital circuit portion 13, the video/audio output circuit 14, and the power supply portion 15. Within the connector 56, near the analog part 50 is arranged the IF output terminal of the tuner circuit portion 11, and via this IF output terminal, the IF signal is outputted. Within the connector 56, apart from the analog part 50 are arranged the output terminal and the ground terminal of the video/audio output circuit 14.

The connector 56 is arranged in a concentrated fashion at one edge of the circuit board (the digital part 60); specifically, the connector 56 is arranged at one edge of the digital part 60 such that the longitudinal direction of the connector 56 forms the letter “L” (that is, substantially a right angle) with respect to the axis of the tuner input terminal 53. In other words, the connector 56 is arranged at the edge of the digital part 60 that is substantially parallel to the axis of the tuner input terminal 53 in such a way as to extend perpendicularly outward therefrom.

The digital demodulating portion 12 and the digital circuit portion 13 are electromagnetically shielded from each other with a second shield plate 52. A multiple-layer circuit board is adopted in the digital part 60, so that the digital demodulating IC 21 provided in the digital demodulating portion 12 and the video/audio processing IC 24 provided in the digital circuit portion 13 are electrically connected to each other via an interlayer conductor pattern laid inside the digital part 60. These two ICs are each mounted in positions apart from each other on the same face of the digital part 60. Moreover, the packages of the digital demodulating IC 21 and the video/audio processing IC 24 each make contact with the chassis 70 via a thermally conductive member laid in between. Thus, the digital ground patterns of the digital demodulating portion 12 and the digital circuit portion 13 are each electrically connected to the chassis 70.

The connection of the digital ground patterns in the digital part 60 to the chassis 70 and the above described connection of the analog ground pattern in the analog part 50 to the chassis 70 are all achieved with solder applied on the bottom face of the circuit board (see solder spots 81 to 88 shown in FIG. 2B). Here, the bottom face of the circuit board denotes the face thereof at which the distance therefrom to the lid is smaller, in other words, the face thereof at which the height with respect thereto of the side faces of the chassis is smaller. Performing soldering on the bottom face of the circuit board helps reduce the likeliness of the soldering machine or tool touching the side faces of the chassis during the manufacturing process of the receiver apparatus. This ensures highly efficient mounting.

Here, as shown in FIG. 2B, the spots at which the ground patterns are connected to the chassis are located not only at one edge of the circuit board (the analog part 50 and the digital part 60) but at a plurality of edges (or all the edges) thereof. This increases the number of connection points between the chassis and the ground patterns, and thus helps reduce connection impedance. In the example shown in FIG. 2B, the soldering spots are located at all edges of the circuit board. This permits an increased number of connection points to be efficiently distributed over a wider area, contributing to an accordingly low impedance.

The digital circuit portion 13 has the video/audio processing IC 24 mounted on one face (top face) thereof, and has the video/audio processing memory 22 and the program memory 23 mounted on the other face (bottom face) thereof. There is laid an interlayer conductor pattern via which the video/audio processing IC 24, the video/audio processing memory 22, and the program memory 23 are electrically connected together.

The power supply terminals of the tuner circuit portion 11, the digital demodulating portion 12, the digital circuit portion 13, and the video/audio output circuit 14 are arranged, within the connector 56, between the output terminal of the video/audio output circuit 14 and the IF output terminal of the tuner circuit portion 11.

With the configuration described above, as a result of the digital circuit portion 13 and the video/audio output circuit 14 being mounted on the circuit board of the receiver apparatus 3, a video display apparatus 4 needs to be provided only with the display processing portion 31 for displaying video based on the video signal fed from the receiver apparatus 3 and an audio processing portion for outputting audio based on the audio signal fed from the receiver apparatus 3, and thus does not need to be built on a multiple-layer circuit board. In the conventional configuration, since the digital circuit portion is provided in the video display apparatus, measures against the unnecessary electromagnetic emission and noise generated by the video/audio processing IC, the video/audio processing memory, the program memory, and the like need to be taken in the video display apparatus. By contrast, with the configuration according to the present invention, the digital circuit portion 13 is provided in the receiver apparatus 3, and thus the video display apparatus can be configured without a digital circuit portion. This eliminates the need to take measures against unnecessary electromagnetic emission and noise in the video display apparatus.

The digital demodulating IC 21 and the video/audio processing IC 24 mounted on the circuit board of the receiver apparatus 3 are each connected to the chassis 70 via a thermally conductive member laid in between. Thus, measures against the heat generated by the IC packages are taken. On the other hand, in the video display apparatus, which no longer needs to be provided with IC packages, no measures need to be taken against heat as by increasing the area of the circuit board or providing it with an additional heat-dissipating plate.

With the configuration according to the present invention, within the receiver apparatus, the analog part 50 composed of analog circuits and the digital part 60 composed of digital circuits are separated from each other. This prevents the digital noise generated by the digital demodulating portion 12 and the digital circuit portion 13 from entering the tuner circuit portion 11, and thus helps prevent degradation of the performance of the tuner circuit portion 11.

The analog and digital ground patterns are each electrically connected to the chassis 70, and this helps reduce the impedance between the analog and digital grounds.

The connector 56 is provided at one edge of the digital part 60, and, via this connector 56, not only the input/output terminals of the tuner circuit portion 11, but also the input/output terminals related to the functional sections mounted on the digital part 60, namely the digital demodulating portion 12, the digital circuit portion 13, the video/audio output circuit 14, and the power supply portion 15, achieve connection. This makes the design of the conductor layout in the video display apparatus easy.

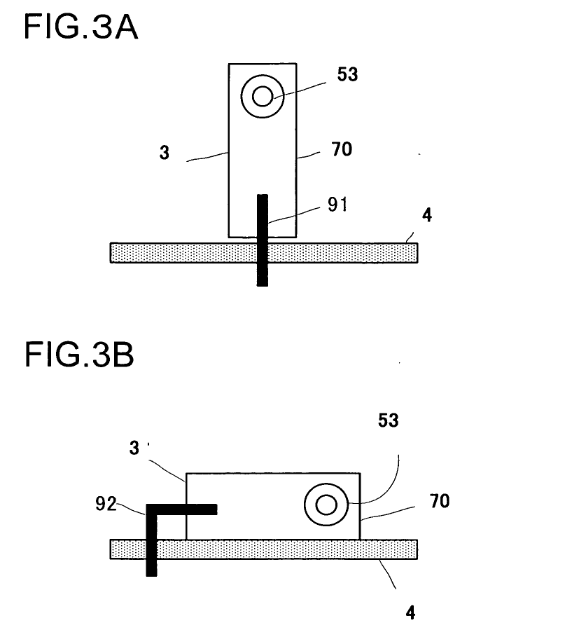

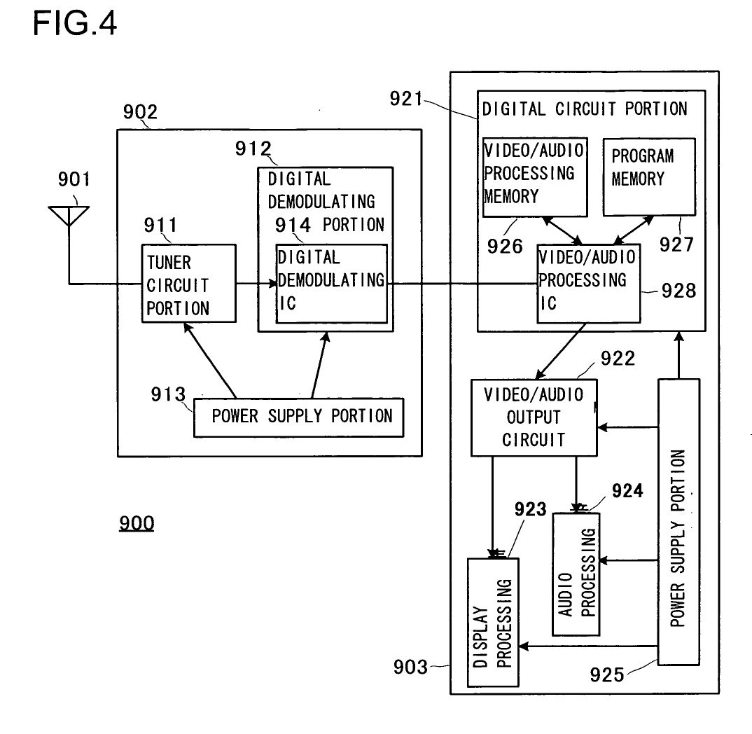

Now, how the receiver apparatus 3 and the video display apparatus 4 are connected together will be described conceptually with reference to the drawings. FIGS. 3A and 3B are diagrams conceptually showing how the receiver apparatus 3 and the video display apparatus 4 shown in FIG. 1 are fitted together. FIG. 3A shows the state where the receiver apparatus 3 is fitted in an upright position on the video display apparatus 4 and FIG. 3B shows the state where the receiver apparatus 3 is fitted in a flat position on the video display apparatus 4.

As shown in FIGS. 3A and 3B, when the receiver apparatus 3 is fitted in an upright position on the video display apparatus 4, the connector 56 and the video display apparatus 4 are connected together with straight connector pins 91; on the other hand, when the receiver apparatus 3 is fitted in a flat position on the video display apparatus 4, the connector 56 and the video display apparatus 4 are connected together with connector pins 92 bent in the “L” shape. That is, with this configuration, whether the receiver apparatus is mounted in a flat position or in an upright position with the edge thereof where the input/output terminals (i.e., the connector 56) are arranged serving as the base, the mounting of the receiver apparatus can be coped with simply by bending or leaving straight the pins serving as the input/output terminals. Thus, whichever of the two arrangements is desirable can be adopted with no design change as in component layout.

The soldering between the pins of the connector 56 and the circuit board (the digital part 60) is performed only on one face (bottom face) thereof, and on the same face on which the ground patterns of the circuit board are soldered to the chassis 70 as described previously. This eliminates the need to turn the circuit board over while, in the manufacturing process of the receiver apparatus, the input/output terminals are soldered to the digital part 60 and the ground patterns of the circuit board are soldered to the chassis, and thus helps reduce the number of manufacturing steps.

Within the connector 56, near the analog part 50 is arranged the IF output terminal of the tuner circuit portion 11, and via this IF output terminal, the IF signal is outputted. On the other hand, within the connector 56, apart from the analog part 50 are arranged the output terminal and the ground terminal of the video/audio output circuit 14. Arranging the output terminal of the tuner circuit portion 11 away from the output terminal of the video/audio output circuit 14 in this way helps prevent the radio-frequency noise generated by the tuner circuit portion 11 from entering the video/audio output circuit 14. Also, this helps prevent the digital noise generated by the digital demodulating portion 12 and the digital circuit portion 13 mounted on the digital part 60 from mixing with the IF signal outputted from the tuner circuit portion 11.

Also, the analog part 50 and the digital part 60 are separated from each other with the shield plate 51. This helps prevent the electromagnetic emission generated by the digital demodulating portion 12 and the digital circuit portion 13 mounted on the digital part 60 from entering the tuner circuit portion 11 mounted on the analog part 50.

In addition, in the digital part 60, the digital demodulating portion 12 and the digital circuit portion 13 are separated from each other with a shield plate. This helps prevent the electromagnetic emission generated by the digital circuit portion 13 from entering the digital demodulating portion 12.

In the digital part 60, the digital demodulating IC 21 provided in the digital demodulating portion 12 and the video/audio processing IC 24 provided in the digital circuit portion 13 are arranged in positions apart from each other on the same mount face. This helps disperse the heat generated by the digital demodulating IC 21 and the heat generated by the video/audio processing. In addition, the packages of these ICs each make contact with the chassis 70 via a thermally conductive member laid in between. This permits the heat to be dissipated to the chassis and the lids, and thus helps alleviate the accumulation of the heat.

With the configuration according to the present invention, which has been described by way of an embodiment above, the digital circuit portion and the video/audio output circuit, which are conventionally incorporated in the video display apparatus, are mounted on the circuit board of the receiver apparatus. This makes it possible to realize the video display apparatus with a single-layer circuit board instead of a multiple-layer circuit board. Furthermore, by performing the soldering of the connector pins and the soldering between the chassis and the ground patterns on the same face, it is possible to reduce the number of manufacturing steps. Moreover, it is possible to change the component mounting in the video display apparatus, with almost no modification in the receiver apparatus.

The digital circuit portion may be provided with: a video/audio processing IC that demodulates compressed digital video and audio signals; and a video/audio processing memory that stores the compressed digital video and audio signals and demodulated digital video and audio signals, and, on the single circuit board, the video/audio processing memory may be wired in a position opposite from the tuner circuit portion and arranged on the face opposite from the video/audio processing IC.

In the conventional configuration, since the digital circuit portion is provided in the video display apparatus, measures against the unnecessary electromagnetic emission and noise generated by the video/audio processing IC, the video/audio processing memory, the program memory, and the like need to be taken in the video display apparatus. By contrast, with the configuration according to the present invention, the digital circuit portion is provided in the receiver apparatus, and thus the video display apparatus can be configured without a digital circuit portion. This eliminates the need to take measures against unnecessary electromagnetic emission and noise in the video display apparatus. Furthermore, this prevents the digital noise generated by the video/audio processing memory from entering the tuner circuit portion, and thus helps prevent degradation of the performance of the tuner circuit portion.

The digital demodulating portion may be provided with a digital demodulating IC, which is a processing IC for converting the intermediate-frequency signal into a digital signal, and, on the single circuit board, the digital demodulating IC and the video/audio processing IC may be arranged in positions apart from each other on the same mounting face.

With this configuration, it is possible to disperse the heat generated by the digital demodulating IC provided in the digital demodulating portion and the heat generated by the video/audio processing IC provided in the digital circuit portion.

On the single circuit board, the digital demodulating IC and the video/audio processing IC may each make contact with the chassis via a thermally conductive member laid in between.

With this configuration, it is possible to disperse the heat generated by the digital demodulating IC and the heat generated by the video/audio processing IC to the chassis and the lids of the circuit board, and thereby to alleviate the accumulation of heat on the circuit board.

The single circuit board may be a multiple-layer circuit board, and the video/audio processing IC and the video/audio processing memory may be wired together with an inner layer wiring pattern.

With this configuration, it is possible to prevent unnecessary electromagnetic emission generated by the video/audio processing memory.

The single circuit board may be a multiple-layer circuit board, and the video/audio processing IC and the digital demodulating IC may be wired together with an inner layer wiring pattern.

With this configuration, it is possible to prevent unnecessary electromagnetic emission generated by the digital demodulating IC.

On the single circuit board, the input/output terminals of the tuner circuit portion, the digital demodulating portion, the digital circuit portion, and the video/audio output circuit may be arranged in a concentrated fashion at one edge of the single circuit board.

On the single circuit board, the output terminal and a ground terminal of the video/audio output circuit may be arranged in positions opposite from the tuner circuit portion.

With this configuration, it is possible to prevent the radio-frequency noise generated by the tuner circuit portion from entering the video/audio output circuit.

On the single circuit board, an IF output terminal for outputting the intermediate-frequency signal obtained through conversion by the tuner circuit portion may be arranged in a position near the tuner circuit portion.

With this configuration, it is possible to prevent the digital noise generated by the digital demodulating portion and the digital circuit portion from mixing with the intermediate-frequency signal outputted from the tuner circuit portion.

A power supply portion may be provided for supplying electric power to each of the tuner circuit portion, the digital demodulating portion, the digital circuit portion, and the video/audio output circuit, and on the single circuit board, power supply terminals for supplying electric power from the power supply portion to the tuner circuit portion, the digital demodulating portion, the digital circuit portion, and the video/audio output circuit may each be arranged between the output terminal of the video/audio output circuit and the IF output

The tuner circuit portion may be separated from the digital demodulating portion, the digital circuit portion and the video/audio output circuit with the first shield plate.

With this configuration, it is possible to prevent the electromagnetic emission generated by the digital demodulating portion and the digital circuit portion on the single circuit board from entering the tuner circuit portion.

On the single circuit board, the digital demodulating portion and the digital circuit portion may be separated from each other with a second shield plate.

With this configuration, it is possible to prevent the electromagnetic emission generated by the digital circuit portion from entering the digital demodulating portion.

According to another aspect of the present invention, a receiver systems that receives digital and analog broadcast signals, converts them into video and audio signals, and displays video and outputs audio according thereto may be provided with: the receiver based on a video signal outputted from the receiver apparatus and/or outputs audio based on an audio signal outputted from the receiver apparatus.

What is claimed is:

1. A receiver apparatus that converts a radio-frequency signal received by an antenna into video and audio signals, comprising:
a tuner circuit portion that converts the radio-frequency signal received by the antenna into an intermediate-frequency signal;
a digital demodulating portion that converts the intermediate-frequency signal outputted from the tuner circuit portion into a compressed digital signal;
a digital circuit portion that converts the compressed digital signal outputted from the digital demodulating portion into digital video and audio signals; and
a video/audio output circuit that converts the digital video and audio signals outputted from the digital circuit portion into analog video and audio signals,
wherein
the tuner circuit portion, the digital demodulating portion, the digital circuit portion, and the video/audio output circuit are arranged on a single circuit board, and
top and bottom faces of the single circuit board are entirely covered with a chassis.

2. The receiver apparatus of claim 1, wherein
the single circuit board is enclosed in the chassis.

3. The receiver apparatus of claim 1,
wherein
a first block including the tuner circuit portion and a second block including the digital demodulating portion, the digital circuit portion, and the video/audio output circuit are separated from each other with a first shield plate,
an analog ground pattern of the first block and a digital ground pattern of the second block are electrically connected to the chassis, and
an analog ground pattern and an digital ground pattern of the single circuit board are both connected to the chassis with solder applied on one face of the single circuit board.

4. The receiver apparatus of claim 1,
wherein
a first block including the tuner circuit portion and a second block including the digital demodulating portion, the digital circuit portion, and the video/audio output circuit are separated from each other with a first shield plate,
an analog ground pattern of the first block and a digital ground pattern of the second block are electrically connected to the chassis,
an analog ground pattern and a digital ground pattern of the single circuit board are both connected to the chassis with solder applied on one face of the single circuit board, and
the analog ground pattern and the digital ground pattern are both connected to the chassis with solder applied on a bottom face of the single circuit board

5. The receiver apparatus of claim 1,
wherein
a first block including the tuner circuit portion and a second block including the digital demodulating portion, the digital circuit portion, and the video/audio output circuit are separated from each other with a first shield plate,
an analog ground pattern of the first block and a digital ground pattern of the second block are electrically connected to the chassis,
an analog ground pattern and a digital ground pattern of the single circuit board are both connected to the chassis with solder applied on one face of the single circuit board, and
the analog ground pattern and the digital ground pattern are each connected to the chassis with solder applied at a plurality of edges of the single circuit board.

6. The receiver apparatus of claim 1,
wherein
a first block including the tuner circuit portion and a second block including the digital demodulating portion, the digital circuit portion, and the video/audio output circuit are separated from each other with a first shield plate,
an analog ground pattern of the first block and a digital ground pattern of the second block are electrically connected to the chassis,
an analog ground pattern and a digital ground pattern of the single circuit board are both connected to the chassis with solder applied on one face of the single circuit board, and
the analog ground pattern and the digital ground pattern are both connected to the chassis with solder applied at all edges of the single circuit board.

7. The receiver apparatus of claim 1,
wherein
input/output terminals of the tuner circuit portion, the digital demodulating portion, the digital circuit portion, and the video/audio output circuit are arranged in a concentrated fashion at one edge of the single circuit board,
the input/output terminals are arranged so as to extend outward from the one edge in a direction substantially perpendicular thereto, and
the one edge is substantially parallel to an axis of a tuner input terminal via which the radio-frequency signal received by the antenna is fed to the tuner circuit portion.

8. The receiver apparatus of claim 7, wherein
the input/output terminals of the tuner circuit portion, the digital demodulating portion, the digital circuit portion, and the video/audio output circuit are all connected to the single circuit board with solder applied on a same face thereof on which the ground patterns of the single circuit board are connected to the chassis with solder.

9. A receiver system that receives digital and analog broadcast signals, converts them into video and audio signals, and displays video and outputs audio according thereto, the receiver system comprising:
the receiver apparatus of claim 1; and
a video display apparatus that displays video based on a video signal outputted from the receiver apparatus and/or outputs audio based on an audio signal outputted from the receiver apparatus.
